(19) United States
(12) Patent Application Publication
(10) Pub. No.: US 2004/0163503 A1
(43) Pub. Date: Aug. 26, 2004

(54) Angle adjustable hand tools

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/370,506

(22) Filed: Feb. 24, 2003

(51) Int. Cl. B25B 23/16

(52) U.S. Cl. 81/177.8

(57) ABSTRACT

An angle adjustable hand tool includes a handle having two lugs extending from an end thereof and a function end having an insertion extending from a surface thereof. The insertion is pivotably connected between the two lugs. Two shoulders extend from two sides of the surface and respectively contact top or bottom surface of the lugs when the function end is pivoted at a pre-set maximum angle such as 60 degrees.

### FIELD OF THE INVENTION

The present invention relates to a hand tool such as pliers or a wrench, which has a function end that can be pivoted at a certain angle to allow users to rotate the hand tool effectively.

### BACKGROUND OF THE INVENTION

A conventional tool box with a pivotable function end is shown in FIG. 20 and includes a handle portion 100 and a function end 101 which is pivotable about a pin at an angle so that the tool may access an object at an angle. When the handle portion 100 is pivoted 30 degrees relative to a horizontal surface, a horizontal component force is sufficient for the users to rotate the handle portion 100. When the handle portion 100 is pivoted 60 degrees relative to a horizontal surface as shown in FIG. 21, the horizontal component force is reduced and the users have to rotate with a lot of efforts. When the handle portion 100 is pivoted 90 degrees relative to a horizontal surface as shown in FIG. 22, the horizontal component force is zero and it is difficult to rotate the tool. This is similar for pliers that have a pivotable function end 101 as shown in FIG. 23, when the handle portion 100 is pivoted 90 degrees relative to a horizontal surface as shown in FIG. 24, the horizontal component force is zero.

The present invention intends to provide an angle adjustable function end for a hand tool wherein the maximum angle can be maintained so as to provide sufficient horizontal force to rotate the tool.

### SUMMARY OF THE INVENTION

In accordance with one aspect of the present invention, there is provided a hand tool which comprises a handle having two lugs extending from an end thereof and a function end having an insertion which is pivotably connected between the two lugs. Two shoulders extend from two sides of a surface from which the insertion extends, and respectively contact the lugs when the function end is pivoted at a pre-met maximum angle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a wrench of the present invention;

FIG. 2 is a side view to show the shoulders on the function end contact the surface of the lugs on the handle;

FIG. 3 shows an enlarged view of the contact portion of the shoulders and the lugs;

FIG. 4 is an exploded view to show a pair of pliers of the present invention;

FIG. 5 is a perspective view to show the pliers of the present invention;

FIG. 6 shows the handles of the pliers are pivoted at a maximum angle;

FIG. 7 shows another embodiment of the wrench of the present invention;

FIG. 8 is a perspective view to show the wrench of the present invention as shown in FIG. 7;

FIG. 9 is a top view of the wrench of the present invention as shown in FIG. 7;

FIG. 10 is a side view of the wrench of the present invention as shown in FIG. 7;

FIG. 11 is a side view to show the shoulders on the function end contact the surface of the lugs on the handle of the wrench as shown in FIG. 7;

FIG. 12 shows an enlarged view of the contact portion of the shoulders and the lugs as shown in FIG. 11;

FIGS. 13 and 14 show that the maximum angle between the handle to the horizontal surface is set to be 45 degrees and 30 degrees respectively;

FIG. 15 is an exploded view to show another embodiment of a pair of pliers of the present invention;

FIG. 16 is a perspective view to show the pliers of the present invention as shown in FIG. 15;

FIG. 17 shows the handle is pivoted 60 degrees relative to the horizontal surface;

FIG. 18 shows a perspective view of the pliers as shown in FIG. 17;

FIG. 19 shows the hand tool of the present invention is a ratchet tool;

FIGS. 20 to 22 show different angles of the handle relative to the horizontal surface of a conventional hand tool;

FIG. 23 shows a conventional pair of angle adjustable pliers, and

FIG. 24 shows the handles of the conventional pair of angle adjustable pliers are pivoted relative to the function ends.

### DETAILED DESCRIPTION OF THE PREFERRED EMBODIMENT

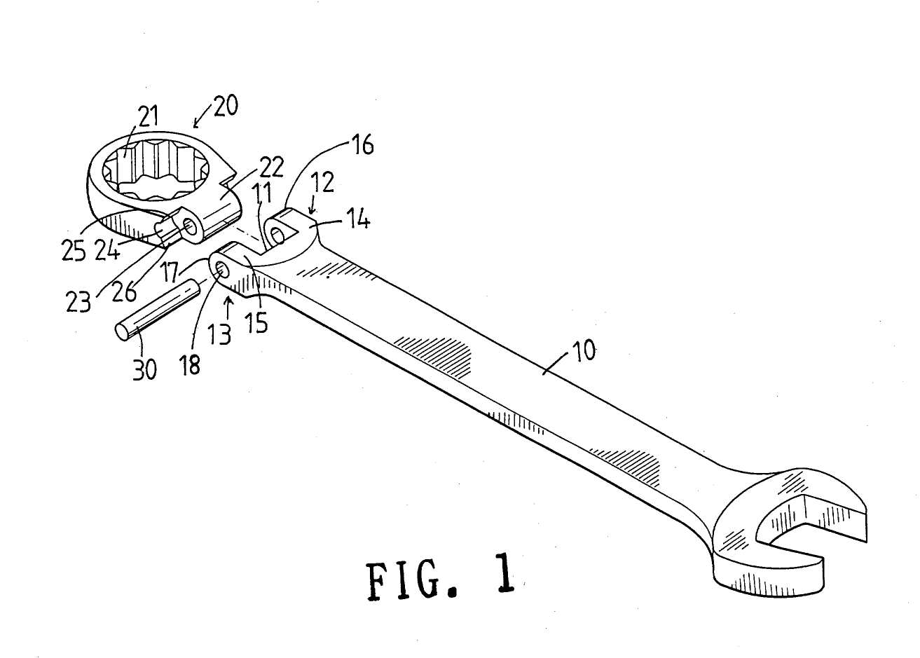

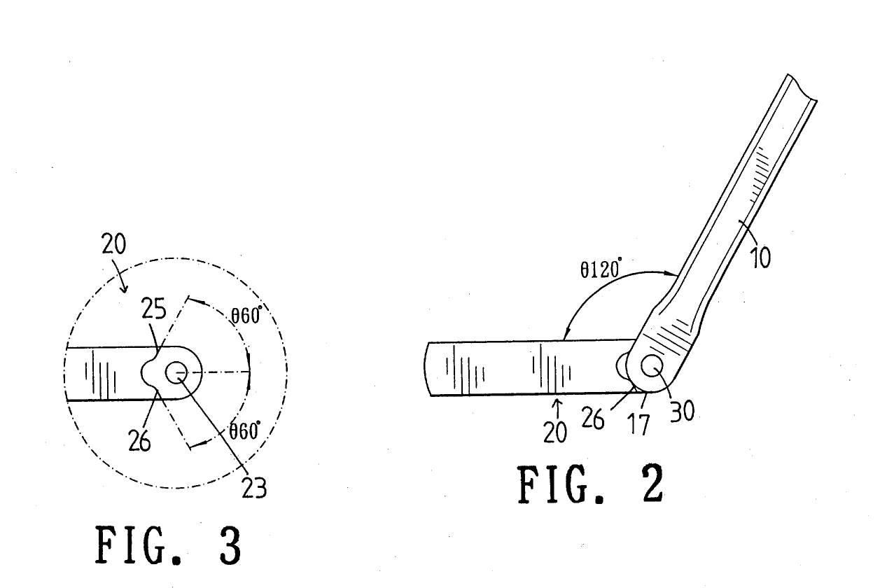

Referring to FIG. 1, the first embodiment of the angle adjustable hand tool of the present invention is a wrench which comprises a handle 10 having two lugs 12, 13 extending from an end 11 thereof and each of the two lugs 12, 13 has a rounded distal end 16/17. A function end 20 such as a box end having a has an insertion 22 extending from a surface thereof and the insertion 22 is pivotably connected between the two lugs 12, 13 by extending a pin 30 through holes 18 defined through the two lugs 12, 13 and a passage 23 defined through the insertion 22. Two shoulders 25, 26 extend from two sides of the surface and a groove 24 is defined in the surface of the function end 20. Each of the grooves 24 is located between the shoulders 25, 26 so that the rounded distal ends 16, 17 are smoothly engaged with the grooves 24. As shown in FIGS. 2 and 3, when the handle 10 is pivoted relative to the function end 20 to a pre-set maximum angle such as 60 degrees, the shoulders 25, 26 contact the top surface 14/15 or the bottom surface of the two lugs 12, 13 so limit the handle 10 from continuously pivoting about the pin 30.

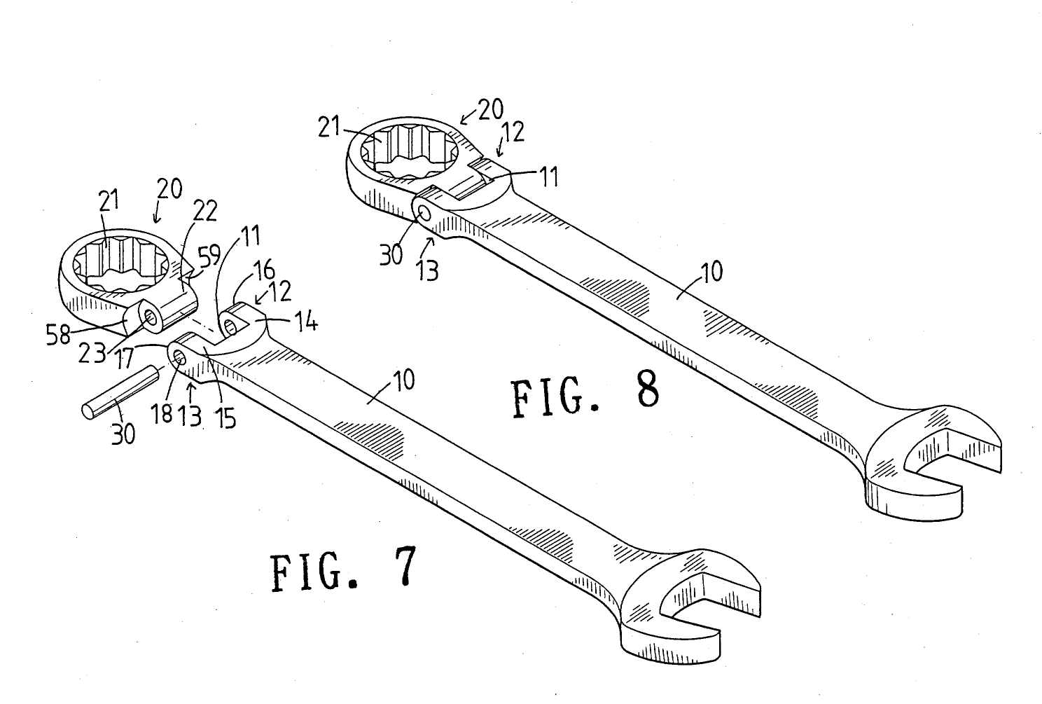

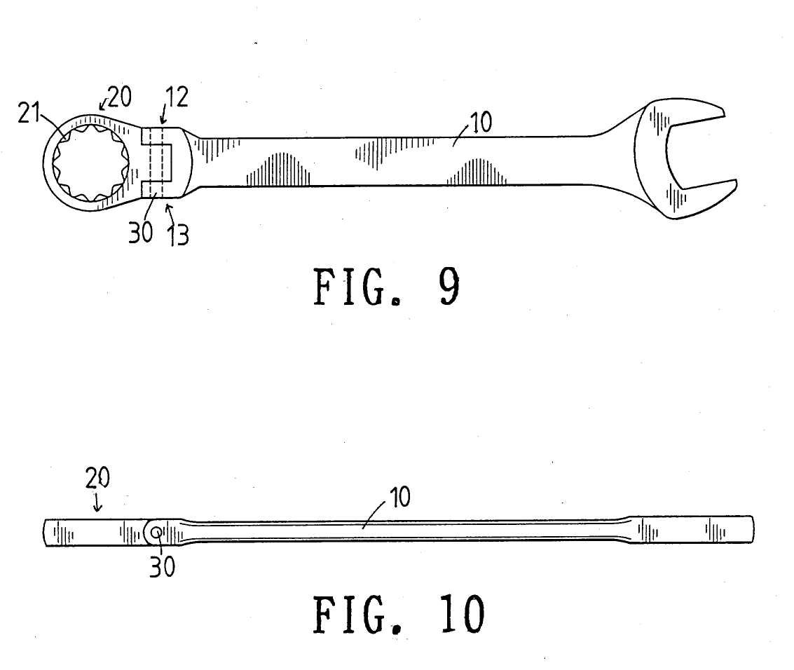

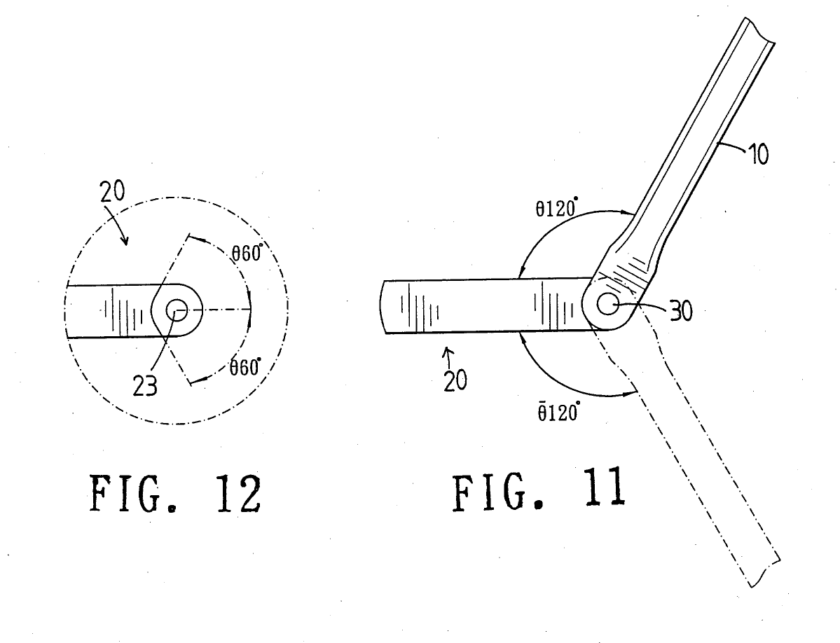

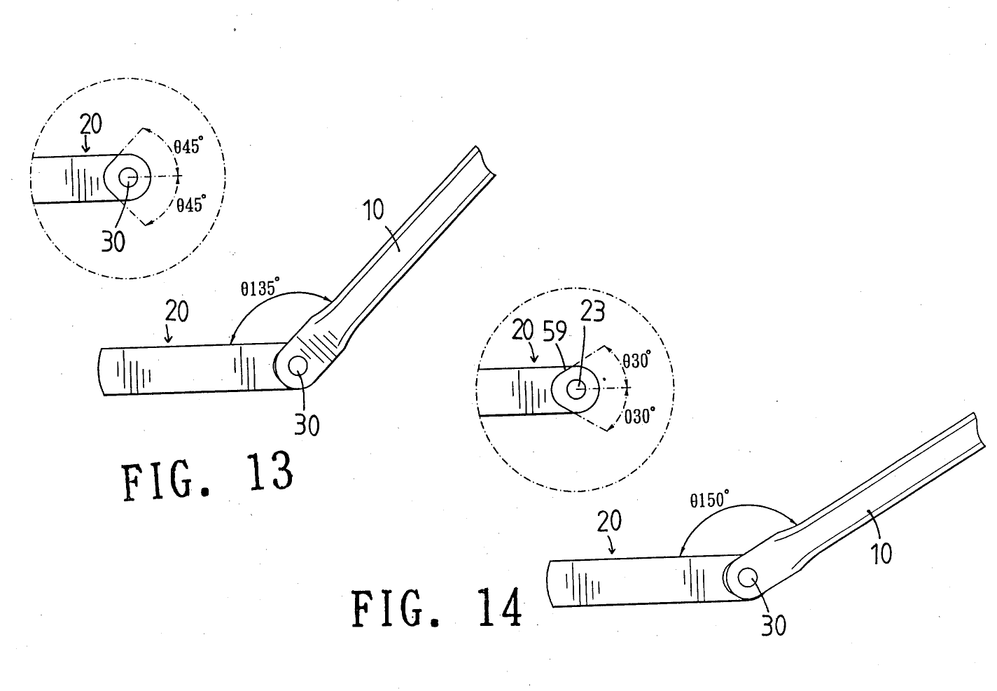

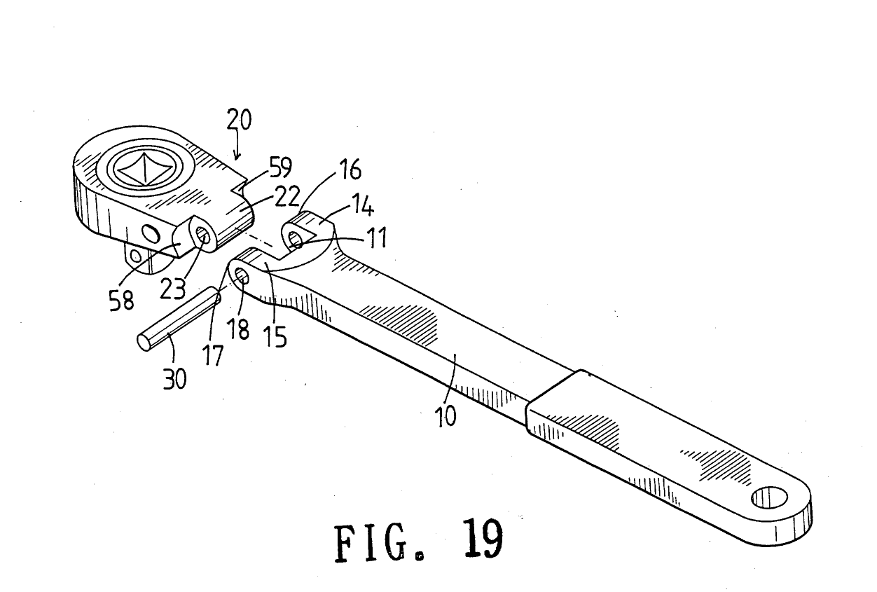

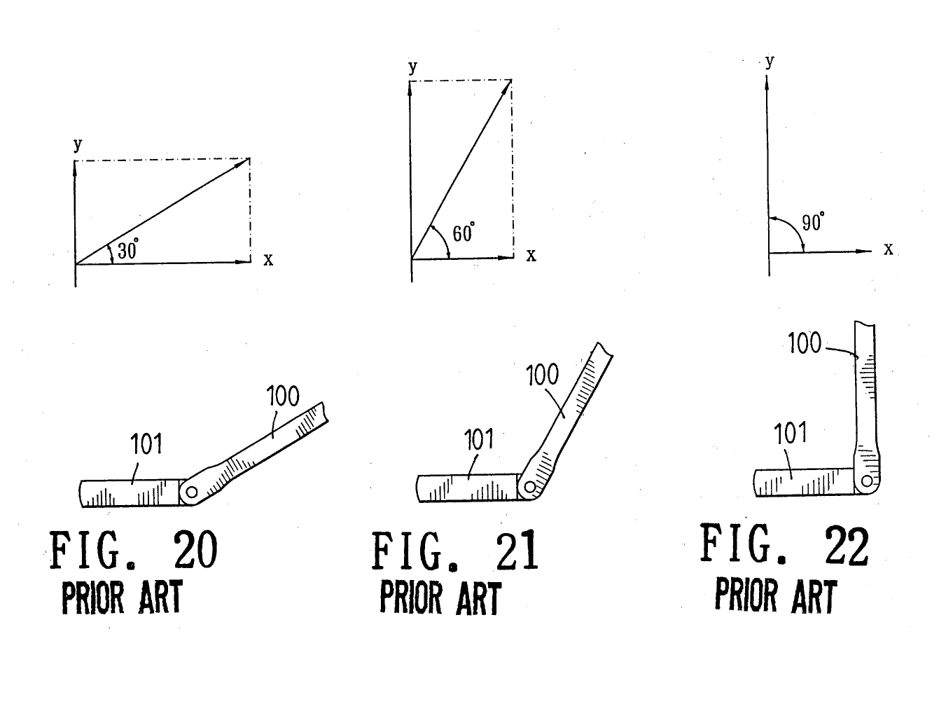

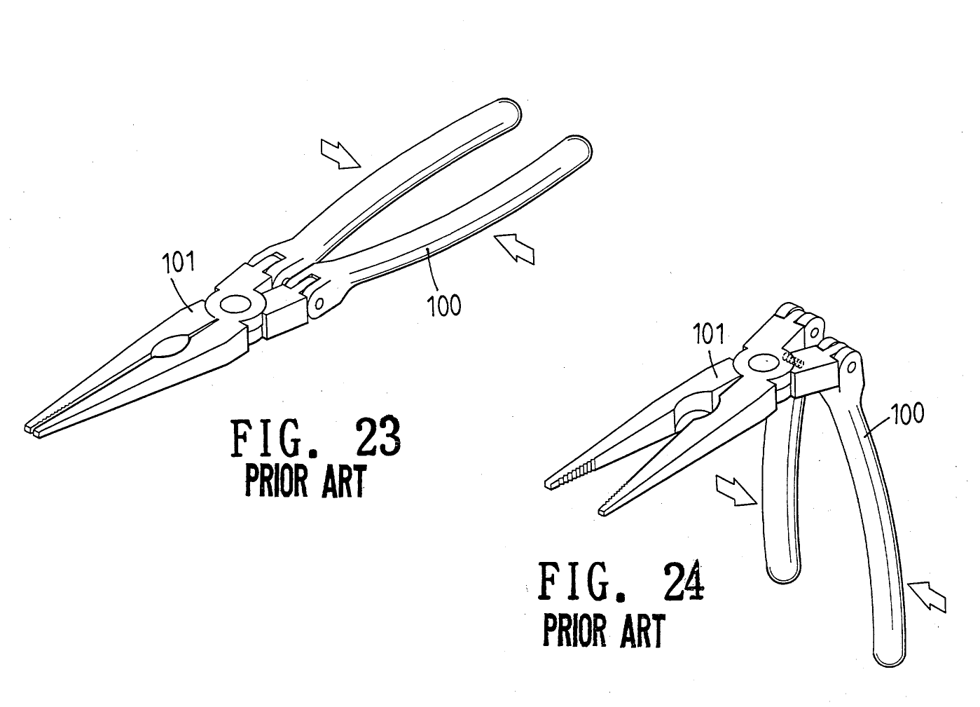

As shown in FIGS. 7 to 12, the shoulders as shown in FIG. 1 can also be omitted and the grooves 58, 59 extended to the whole height of the surface of the function end 20. Because of the curvature of the grooves 58, 59, the two edges of the grooves 58, 59 may contact the top surface 14/15 or the bottom surface of the two lugs 12, 13. The curvature can be set according to practical needs so that the handle 10 is stopped from continuously pivoting about the pin 30 at 45 degrees as shown in FIG. 13 or 30 degrees as shown in FIG. 14. FIG. 19 shows that the wrench can also be a ratchet wrench wherein the polygonal inner periphery 21 is replaced with a ratchet mechanism (not shown) and an engaging member received in the function end 20.

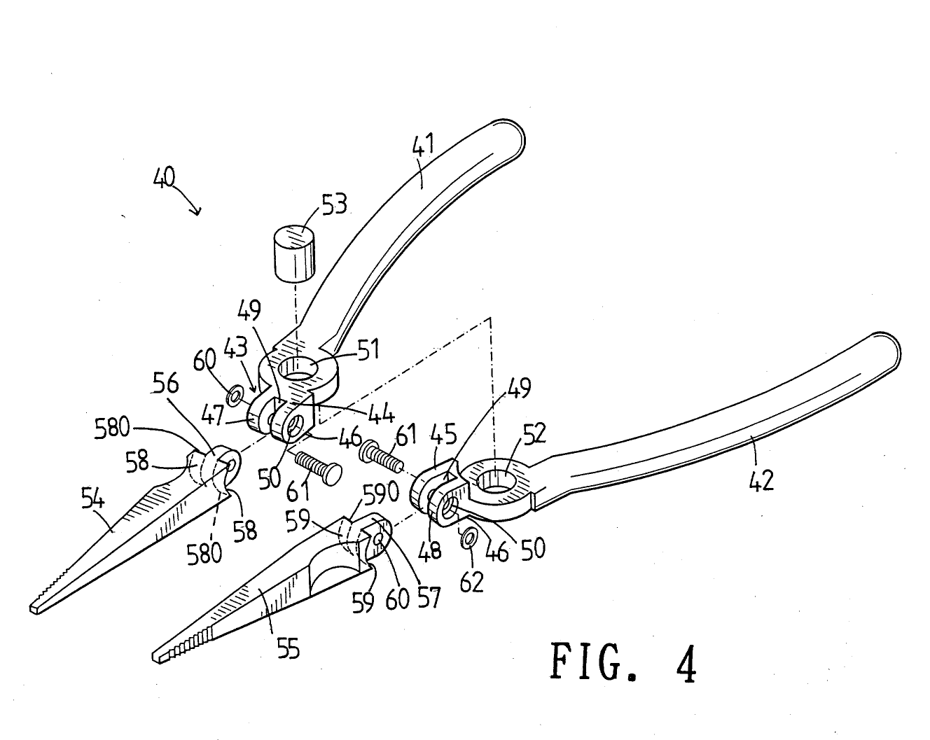

A second embodiment of the hand tool of the present invention is a pair of pliers 40 as shown in FIGS. 4 and 5, and includes two handles 41, 42 each having two lugs 43, 44/45, 46 extending from an end 49 thereof.

The two handles 41, 42 are pivotably connected with each other by using a pin 53 extending through two holes 51, 52 respectively defined through the two handles 41, 42. Each of the two lugs 43, 44, 45, 46 has a rounded distal end 47/48.

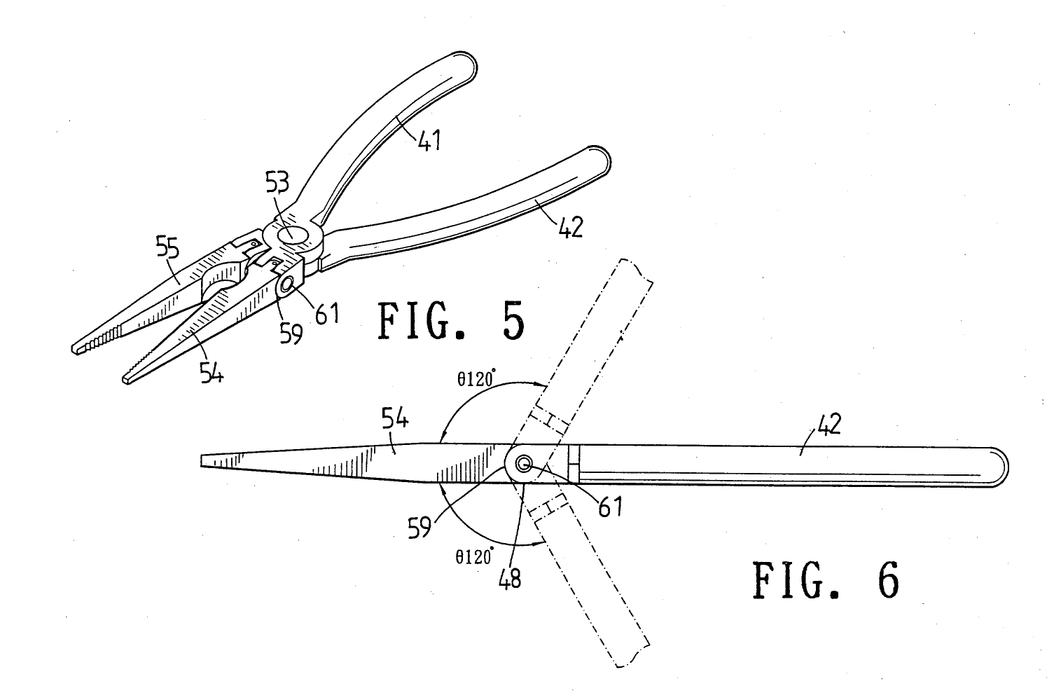

Two function ends 54, 55 each have an insertion 56/57 extending from a surface thereof and each of the insertions 56, 57 is pivotably connected between the two lugs 43, 44/45, 46 of respective one of the two handles 54, 55 by using a bolt 61 extending through the holes defined through the two lugs 43, 44/45, 46, the holes 60 of the insertion 56/57 and engaged with a nut 62. Two grooves 58/59 are defined in the surface of each of the function ends 54, 55, and each of the grooves 58/59 is located between the shoulders or edges 580/590 which extend from two sides of each of the surfaces and respectively contact the top surface and the bottom surface of the lugs 43, 44/45, 46 when the function ends 54, 55 are pivoted at a maximum angle such as 60 degrees as shown in FIG. 6.

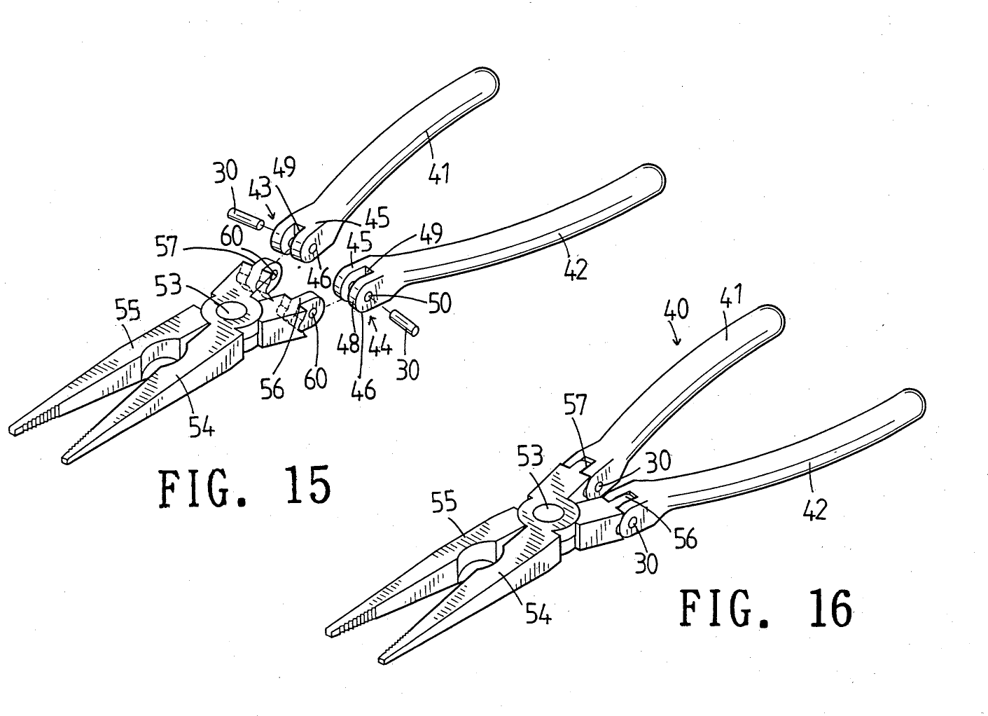

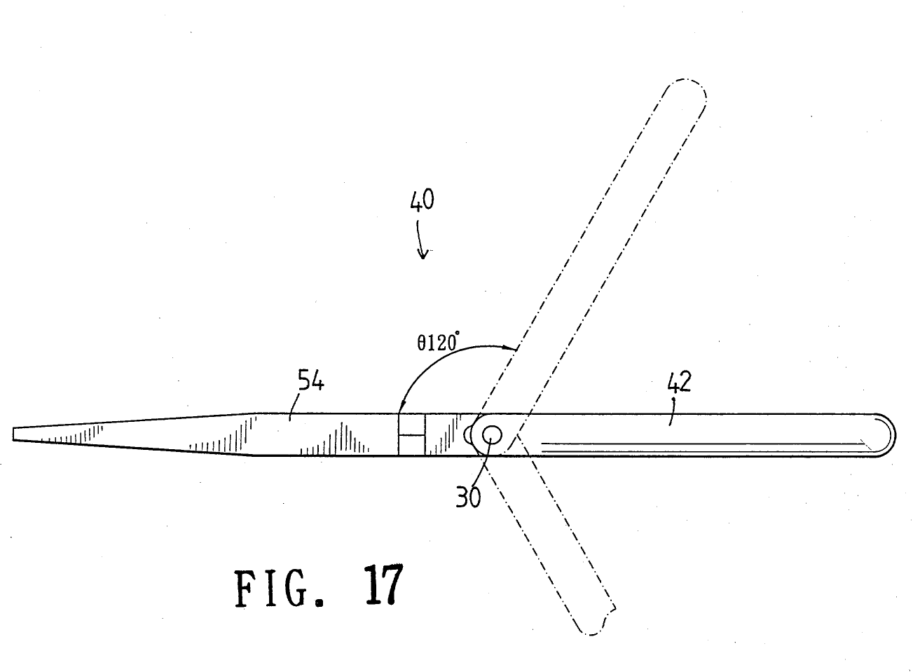

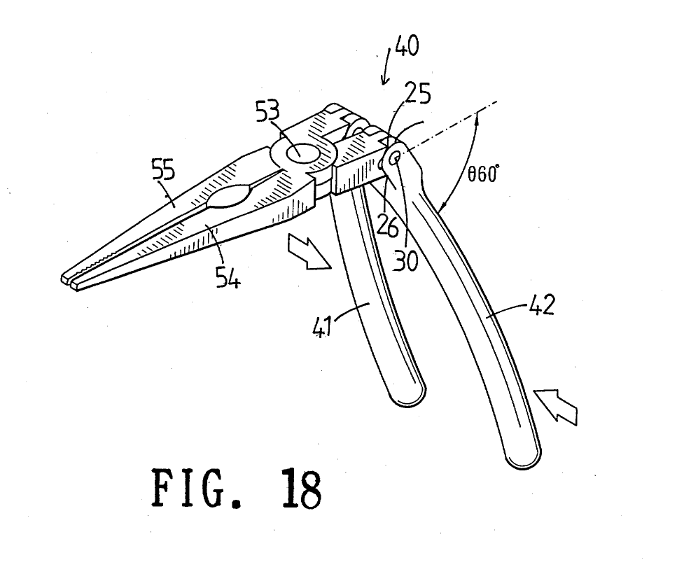

FIGS. 15 to 18 shows another embodiment of the pliers wherein the two function ends 54, 55 are pivotably connected with each of the by a pin 53 and the handles 41, 42 are pivotably connected to the two function ends 54, 55 by pins 30.

While we have shown and described the embodiment in accordance with the present invention, it should be clear to those skilled in the art that further embodiments may be made without departing from the scope of the present invention.

What is claimed is:

1. A hand tool comprising:
a handle having two lugs extending from an end thereof, and
a function end having an insertion extending from a surface thereof and the insertion pivotably connected between the two lugs, two shoulders extending from two sides of the surface and respectively contacting the lugs when the function end is pivoted at a maximum angle.

2. The hand tool as claimed in claim 1, wherein each of the two lugs having a rounded distal end which is smoothly engaged with two grooves defined in the surface of the function end, each of the grooves located between the shoulders.

3. A pair of pliers comprising:
two handles each having two lugs extending from an end thereof, the two handles being pivotably connected with each other, and
two function ends each having an insertion extending from a surface thereof, each of the insertions pivotably connected between the two lugs of respective one of the two handles, two shoulders extending from two sides of each of the surfaces and respectively contacting the lugs when the function ends are pivoted at a maximum angle.

4. The hand tool as claimed in claim 3, wherein each of the two lugs has a rounded distal end which is smoothly engaged with two grooves defined in the surface of each of the function ends, each of the grooves located between the shoulders.
